(19) United States
(12) Patent Application Publication
(10) Pub. No.: US 2020/0028636 A1
(43) Pub. Date: Jan. 23, 2020

(54) SIGNAL TRANSMISSION METHOD AND APPARATUS

(71) Applicant: GUANGDONG OPPO MOBILE TELECOMMUNICATIONS CORP., LTD., Dongguan (CN)

(72) Inventor: Hai TANG, Dongguan (CN)

(21) Appl. No.: 16/587,566

(22) Filed: Sep. 30, 2019

Related U.S. Application Data
(63) Continuation of application No. PCT/CN2017/080253, filed on Apr. 12, 2017.

(51) Int. Cl. H04L 5/00; H04W 72/04

(52) U.S. Cl. CPC H04L 5/001; H04W 72/0406; H04L 5/0073; H04W 72/044; H04L 5/0048

(57) ABSTRACT

The present disclosure provides a signal transmission method and apparatus, where the method includes: transmitting a first signal on subcarriers of a plurality of orthogonal frequency division multiplexing (OFDM) symbols, where a frequency offset of the subcarriers exists among the plurality of OFDM symbols. The present disclosure enables the first signal is no longer concentrated on the subcarriers at a specific frequency, but is dispersed more evenly. The interference of the first signal is more even for the signal being transmitted by the neighboring cell terminal device. On one hand, the influence on the data demodulation of the neighboring cell terminal device is reduced; and on the other hand, if the neighboring cell performs interference measurement, the difference in measurement results on different subcarriers is reduced and the accuracy of the interference measurement result is improved.

### CROSS-REFERENCE TO RELATED APPLICATIONS

This application is a continuation of International Application No. PCT/CN2017/080253, filed on Apr. 12, 2017, the disclosure of which is hereby incorporated by reference in its entirety.

### TECHNICAL FIELD

The present disclosure relates to the field of wireless communication technology, and in particular, to a signal transmission method and an apparatus.

### BACKGROUND

In the 5G NR (new radio) system, in order to support multiple beams in uplink and downlink transmission, multiple beams are usually adopted to transmit a CSI-RS (channel state information-reference signal) or an SRS (sounding reference signal) respectively for performing channel measurement. Where the CSI-RS is used for estimation of the downlink channel and the SRS is used for estimation of the uplink channel.

In order to transmit the CSI-RS or SRS by sufficient time domain resources, the CSI-RS or SRS can adopt a larger subcarrier interval than data transmission, thereby obtaining a shorter OFDM (orthogonal frequency division multiplexing) symbol length. Each OFDM symbol transmits the CSI-RS or SRS by adopting one beam. As shown in FIG. 1, the subcarrier interval between subcarriers for transmitting data can adopt 15 kHz, and the subcarrier interval between subcarriers for transmitting the CSR-RS or SRS adopts a subcarrier interval of 60 kHz. Thus, the OFDM symbol length of the CSR-RS or SRS is one quarter of the OFDM symbol length of the data, and four CSR-RSs or SRSs can be transmitted by four beams within the OFDM symbol length of one data, respectively.

According to subcarrier arrangement of the existing LTE (long term evolution), the subcarrier positions on different OFDM symbols are the same. If a cell transmits the CSR-RS or SRS by a larger subcarrier interval (for example, 60 kHz), and a neighboring cell transmits the data by a smaller subcarrier interval (for example, 15 kHz) in the same time domain, the interference of the CSR-RS or SRS on the data is concentrated on specific subcarriers. For example, if starting positions of the carriers are the same, the first, fifth, ninth, . . . subcarriers are interfered. On the one hand, the interference concentrated on the particular subcarriers has a strong power, which will have a greater impact on the data demodulation of these subcarriers. On the other hand, the interference strengths on different subcarriers vary greatly, and if the neighboring cell performs interference measurement, the measurement results on different subcarriers will be very different, and the accuracy is poor. In particular, if the interference measurement is not performed on the above particular subcarriers, an erroneous result of the interference measurement is obtained.

### SUMMARY

In view of this, the present disclosure provides a signal transmission method and apparatus for reducing the influence of transmitting a signal such as a CSR-RS or an SRS with a larger subcarrier interval on data demodulation of a neighbor cell and interference measurement.

The specific technical solutions are as follows:

the present disclosure provides a signal transmission method, where the method includes:

transmitting a first signal on subcarriers of a plurality of orthogonal frequency division multiplexing (OFDM) symbols, wherein a frequency offset of the subcarriers exists among the plurality of OFDM symbols.

According to an implementation of the present disclosure, the transmitting a first signal on subcarriers of a plurality of orthogonal frequency division multiplexing (OFDM) symbols includes:

sending or receiving, by a terminal device, the first signal on the subcarriers of the plurality of OFDM symbols; or

receiving or sending, by a network side device, the first signal on the subcarriers of the plurality of OFDM symbols.

According to an implementation of the present disclosure, the first signal includes:

a channel state information reference signal (CSI-RS), a channel sounding reference signal (SRS), a demodulation reference signal (DMRS), control information, or first data.

According to an implementation of the present disclosure, the plurality of OFDM symbols are continuous in time domain.

According to an implementation of the present disclosure, a first subcarrier interval used for transmitting the first signal on the subcarriers of the plurality of OFDM symbols is different from a second subcarrier interval;

wherein the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, if the first signal includes: the CSI-RS, the SRS, the DMRS or the control information, and a total duration of the plurality of OFDM symbols is: a duration of one OFDM symbol for transmitting data in a slot or a subframe where the plurality of OFDM symbols are located, or a duration of one OFDM symbol obtained according to a subcarrier interval determining a length of the subframe where the plurality of OFDM symbols are located.

According to an implementation of the present disclosure, if the first signal includes the first data, a total duration of the plurality of OFDM symbols is: a duration of one OFDM symbol obtained according to a subcarrier interval determining a length of the subframe where the plurality of OFDM symbols are located.

According to an implementation of the present disclosure, before the transmitting a first signal on subcarriers of a plurality of orthogonal frequency division multiplexing (OFDM) symbols, the method further includes:

determining a frequency offset amount of each subcarrier of the plurality of OFDM symbols relative to a reference subcarrier.

According to an implementation of the present disclosure, the determining a frequency offset amount of each subcarrier of the plurality of OFDM symbols relative to a reference subcarrier includes:

receiving subcarrier offset indication information sent by a network side device; and

determining, according to the subcarrier offset indication information, the frequency offset amount of each subcarrier of the plurality of OFDM symbols relative to the reference subcarrier.

According to an implementation of the present disclosure, the determining a frequency offset amount of each subcarrier of the plurality of OFDM symbols relative to a reference subcarrier includes:

determining the frequency offset amount of each subcarrier of the plurality of OFDM symbols relative to the reference subcarrier; and

sending, according to the determined frequency offset amount, subcarrier offset indication information to a terminal device.

According to an implementation of the present disclosure, the reference subcarrier includes: a subcarrier of a first OFDM symbol of the plurality of OFDM symbols; or

a first subcarrier of a physical resource block (PRB) where the plurality of OFDM symbols are located; or

a center carrier on system bandwidth; or,

a DC carrier; or,

a subcarrier closest to a center frequency point; or,

a center carrier on bandwidth allocated to the terminal device; or,

a center carrier on bandwidth for transmitting a sync signal.

According to an implementation of the present disclosure, the frequency offset is in units of a first subcarrier interval or a second subcarrier interval;

wherein the first subcarrier interval is a subcarrier interval used for transmitting the first signal on the subcarriers of the plurality of OFDM symbols; and

the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, the determining a frequency offset amount of each subcarrier of the plurality of OFDM symbols relative to a reference subcarrier includes:

determining, according to the number of the plurality of OFDM symbols, the frequency offset amount of each subcarrier of the plurality of OFDM symbols relative to the reference subcarrier.

According to an implementation of the present disclosure, the frequency offset amount is: p first subcarrier intervals, or K+p first subcarrier intervals, or K second subcarrier intervals;

wherein 0≤p<1 and K is a natural number,

the first subcarrier interval is a subcarrier interval used for transmitting the first signal on the subcarriers of the plurality of OFDM symbols; and

the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, the frequency offset of the subcarriers exists among the plurality of OFDM symbols includes: frequency points where subcarriers corresponding to a same subcarrier index on the plurality of OFDM symbols are located are different.

According to an implementation of the present disclosure, the transmitting a first signal on subcarriers of a plurality of orthogonal frequency division multiplexing (OFDM) symbols includes:

determining, according to the frequency offset, a frequency position of a subcarrier on each of the plurality of OFDM symbols; and

transmitting the first signal at the determined frequency position of the subcarrier on the plurality of OFDM symbols.

According to an implementation of the present disclosure, the transmitting a first signal on subcarriers of a plurality of orthogonal frequency division multiplexing (OFDM) symbols includes:

determining, according to the frequency offset, a phase or a delay of a time domain signal transmitting the first signal on the plurality of OFDM symbols; and

transmitting, according to the phase or the delay of the time domain signal, the first signal on the plurality of OFDM symbols.

The present disclosure further provides a signal transmission apparatus, wherein the apparatus includes:

a transmitting unit, configured to transmit a first signal on subcarriers of a plurality of orthogonal frequency division multiplexing (OFDM) symbols, wherein a frequency offset of the subcarriers exists among the plurality of OFDM symbols.

According to an implementation of the present disclosure, the apparatus is disposed in a terminal device, wherein the transmitting unit is specifically configured to send or receive the first signal on the subcarriers of the plurality of OFDM symbols; or

the apparatus is disposed in a network side device, and the transmitting unit is specifically configured to receive or send the first signal on the subcarriers of the plurality of OFDM symbols.

According to an implementation of the present disclosure, the first signal includes:

a channel state information reference signal (CSI-RS), a channel sounding reference signal (SRS), a demodulation reference signal (DMRS), control information, or first data.

According to an implementation of the present disclosure, the plurality of OFDM symbols are continuous in time domain.

According to an implementation of the present disclosure, a first subcarrier interval used for transmitting the first signal on the subcarriers of the plurality of OFDM symbols is different from a second subcarrier interval;

wherein the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, if the first signal includes: the CSI-RS, the SRS, the DMRS or the control information, and a total duration of the plurality of OFDM symbols is: a duration of one an OFDM symbol for transmitting data in a slot or a subframe where the plurality of OFDM symbols are located, or a duration of one OFDM symbol obtained according to a subcarrier interval determining a length of the subframe where the plurality of OFDM symbols are located.

According to an implementation of the present disclosure, if the first signal includes the first data, a total duration of the plurality of OFDM symbols is: a duration of one OFDM symbol obtained according to a subcarrier interval determining a length of the subframe where the plurality of OFDM symbols are located.

According to an implementation of the present disclosure, the apparatus further comprise:

a second determining unit, configured to determine a frequency offset amount of each subcarrier of the plurality of OFDM symbols relative to a reference subcarrier.

According to an implementation of the present disclosure, the second determining unit includes:

a second receiving subunit, configured to receive subcarrier offset indication information sent by a network side device; and

a second determining subunit, configured to determine, according to the subcarrier offset indication information, the frequency offset amount of each subcarrier of the plurality of OFDM symbols relative to the reference subcarrier.

According to an implementation of the present disclosure, the second determining unit includes:

a second determining subunit, configured to determine the frequency offset amount of each subcarrier of the plurality of OFDM symbols relative to the reference subcarrier; and

a second sending subunit, configured to send, according to the determined frequency offset amount determined by the second determining subunit, subcarrier offset indication information to a terminal device.

According to an implementation of the present disclosure, the reference subcarrier includes: a subcarrier of a first OFDM symbol of the plurality of OFDM symbols; or

a first subcarrier of a physical resource block (PRB) where the plurality of OFDM symbols are located; or

a center carrier on system bandwidth; or,

a DC carrier; or,

a subcarrier closest to a center frequency point; or,

a center carrier on bandwidth allocated to the terminal device; or,

a center carrier on bandwidth for transmitting a sync signal.

According to an implementation of the present disclosure, the frequency offset is in units of a first subcarrier interval or a second subcarrier interval;

wherein the first subcarrier interval is a subcarrier interval used for transmitting the first signal on the subcarriers of the plurality of OFDM symbols; and

the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, the second determining unit is specifically configured to:

determine, according to the number of the plurality of OFDM symbols, the frequency offset amount of each subcarrier of the plurality of OFDM symbols relative to the reference subcarrier.

According to an implementation of the present disclosure, the frequency offset amount is: p first subcarrier intervals, or K+p first subcarrier intervals, or K second subcarrier intervals;

wherein 0≤β<1 and K is a natural number,

the first subcarrier interval is a subcarrier interval used for transmitting the first signal on the subcarriers of the plurality of OFDM symbols; and

the second subcarrier interval is a subcarrier interval used for transmitting second data in a slot or a subframe where the plurality of OFDM symbols are located, or a subcarrier interval for determining a length of the subframe where the plurality of OFDM symbols are located.

According to an implementation of the present disclosure, the frequency offset of the subcarriers exists among the plurality of OFDM symbols includes: frequency points where subcarriers corresponding to a same subcarrier index on the plurality of OFDM symbols are located are different.

According to an implementation of the present disclosure, the transmitting unit is specifically configured to:

determine, according to the frequency offset, a frequency position of a subcarrier on each of the plurality of OFDM symbols; and

transmit the first signal at the determined frequency position of the subcarrier on the plurality of OFDM symbols.

According to an implementation of the present disclosure, the transmitting unit is specifically configured to:

determine, according to the frequency offset, a phase or a delay of a time domain signal transmitting the first signal on the plurality of OFDM symbols; and

transmit, according to the phase or the delay of the time domain signal, the first signal on the plurality of OFDM symbols.

It can be seen from the above technical solutions that a frequency offset of subcarriers exists among a plurality of OFDM symbols used for transmitting the first signal in the present disclosure, so that the first signal is no longer concentrated on the subcarriers at a specific frequency, but is dispersed more evenly. When the first signal, such as a CRS-RS/an SRS, is transmitted in the way of the present disclosure, the interference of the first signal is more even for the signal being transmitted by the neighboring cell terminal device. On one hand, the influence on the data demodulation of the neighboring cell terminal device is reduced; and on the other hand, if the neighboring cell performs interference measurement, the difference in measurement results on different subcarriers is reduced and the accuracy of the interference measurement result is improved.

### BRIEF DESCRIPTION OF DRAWINGS

FIG. 1 is a resource schematic diagram for transmitting a CSI-RS or an SRS in the prior art;

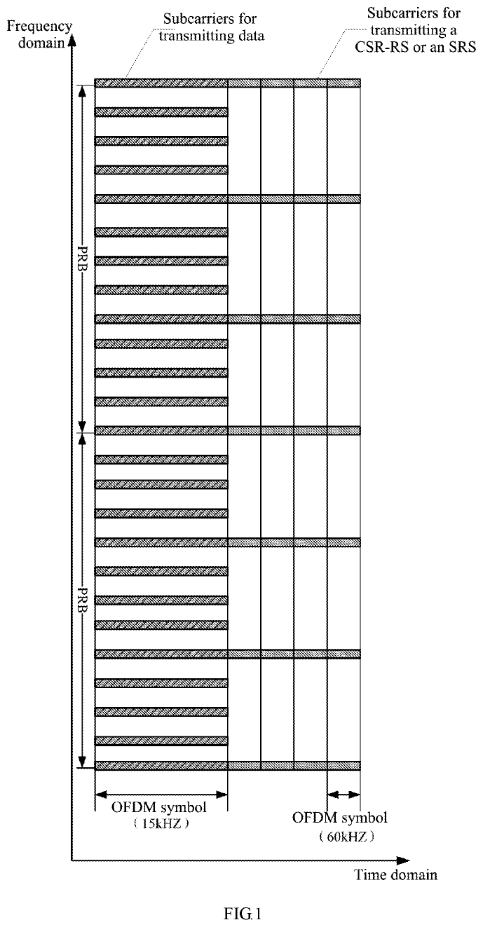

FIG. 2 is a flow chart of a method performed at a terminal device side provided by an embodiment of the present disclosure;

FIG. 3 is a resource schematic diagram for transmitting a first signal provided by an embodiment of the present disclosure;

FIG. 4 is a flow chart of a method performed by a network side device provided by an embodiment of the present disclosure;

FIG. 5a is a schematic structural diagram of an apparatus disposed in a terminal device provided by an embodiment of the present disclosure; and

FIG. 5b is a schematic structural diagram of an apparatus disposed in a device at a network side provided by an embodiment of the present disclosure.

### DESCRIPTION OF EMBODIMENTS

In order to make the purpose, technical solutions and advantages of the present disclosure clearer, the present disclosure will be described in detail below with reference to drawings and specific embodiments.

The terms used in the embodiments of the present disclosure are only for the purpose of describing particular embodiments and are not intended to limit the present disclosure.

Depending on the context, the word “if” used herein can be interpreted as “at the time of” or “when” or “in response to determining” or “in response to detecting”. Similarly, depending on the context, the phrase “if determining” or “if detecting (conditions or events stated)” can be interpreted as “when determining” or “in response to determining” or “when detecting (conditions or events stated)” or “in response to detecting (conditions or events stated)”. “A plurality of” related in the embodiments of the present disclosure refers to more than one.

The core idea of the present disclosure is that a frequency offset of subcarriers exists between a plurality of OFDM symbols when the first signal is transmitted on the subcarriers of the plurality of OFDM symbols. That is to say, positions of the subcarriers on different OFDM symbols transmitting the first signal are no longer the same, but there is an offset in frequency.

Where the above transmission can include sending and receiving. In an embodiment of the present disclosure, the process includes: transmitting, by a terminal device side, a first signal on subcarriers of a plurality of OFDM symbols, or receiving, by the terminal device side, a first signal on subcarriers of a plurality of OFDM symbols, or transmitting, by a network side device, a first signal on subcarriers of a plurality of OFDM symbols, or receiving, by the network side device, a first signal on subcarriers of a plurality of OFDM symbols. The terminal device involved in the embodiment of the present disclosure can include, but is not limited to, a mobile phone, a tablet computer, a notebook computer, a PDA, a multimedia device, or even an internet car, a smart wearable device, or the like having a wireless communication function. The network side device involved in the embodiment of the present disclosure can include, but is not limited to, a base station device such as a BST, a NodeB, or an eNodeB. The method provided by the present disclosure will be described in detail below with reference to the embodiments.

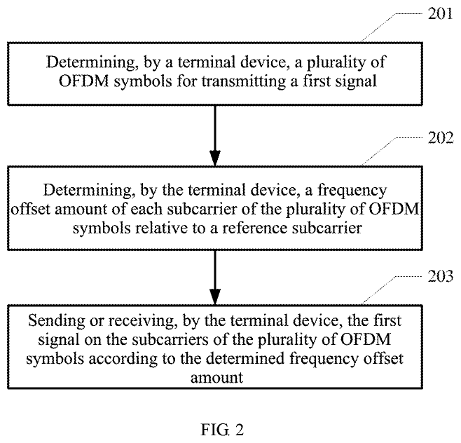

FIG. 2 is a flow chart of a method performed at a terminal device side provided by an embodiment of the present disclosure. As shown in FIG. 2, the method can include the following steps:

in 201, determining, by a terminal device, a plurality of OFDM symbols for transmitting a first signal.

In the embodiment of the present disclosure, the first signal can include a reference signal such as a CSI-RS, an SRS, and a demodulation reference signal (DMRS), can also include a control signal, and can further include data.

The plurality of OFDM symbols (hereinafter referred to as “a plurality of OFDM symbols”) for transmitting the first signal may be a plurality of OFDM symbols that are continuous in the time domain. If the first signal includes a reference signal, such as a CSI-RS, an SRS, or a DMRS, or includes a control signal, a total duration of the plurality of OFDM symbols is usually: a duration of one OFDM symbol for transmitting data in a slot or a subframe where the plurality of OFDM symbols are located, or a duration of one OFDM symbol obtained according to a subcarrier interval determining a length of the subframe where the plurality of OFDM symbols are located. The length of the OFDM symbol used for transmitting the reference signal, the control signal and the like in the subframe can be determined according to the length of the subframe, that is, there is a correspondence relationship between the length of the OFDM symbol and the length of the subframe. And with the correspondence relationship, once the length of the subframe is determined, correspondingly, the total length of the OFDM symbol used for transmitting the first signal in the embodiment of the present disclosure can also be determined.

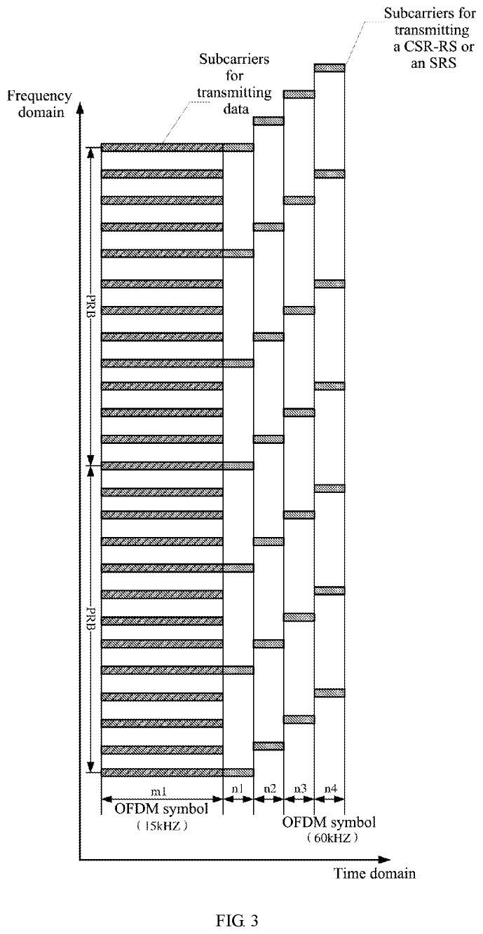

For example, as shown in FIG. 3, four continuous OFDM symbols identified as n1, n2, n3, and n4 can be used for transmitting the first signal, and the total duration of the four OFDM symbols is the same as the duration of the OFDM symbol identified as m1, where the OFDM symbol identified as m1 is used for transmitting data.

If the first signal includes data, the total duration of the plurality of OFDM symbols can be: a duration of one OFDM symbol obtained according to the subcarrier interval determining the length of the subframe where the plurality of OFDM symbols are located.

The subcarrier interval (hereinafter referred to as “first subcarrier interval”) used for transmitting the first signal on the subcarriers of the plurality of OFDM symbols is different from a second subcarrier interval, where the second subcarrier interval is a subcarrier interval used for transmitting data (if the first signal is a non-data type signal, the “transmitting data” here is the data transmitted by the terminal device; if the first signal is a data type signal, the “transmitting data” here is the data transmitted by the other terminal device, such as a neighboring cell terminal device) in the slot or the subframe where the plurality of OFDM symbols are located, or a subcarrier interval for determining the length of the subframe where the plurality of OFDM symbols are located. Usually, the first subcarrier interval is greater than the second subcarrier interval, in an embodiment, the first subcarrier interval is 2ⁿ times the second subcarrier interval, where n is a positive integer. For example, as shown in FIG. 3, the subcarrier interval used in the four OFDM symbols identified as n1, n2, n3, and n4 is 60 kHz, and the subcarrier interval used in the OFDM symbol identified as m1 is 15 kHz, that is, the first subcarrier interval is 4 times the second subcarrier interval.

In addition, the plurality of OFDM symbols used for transmitting the first signal can be determined in a pre-agreed way, that is, the terminal device and the network side device pre-arrange indices of the plurality of OFDM symbols used for transmitting the first signal, and both of them determine positions of the plurality of OFDM symbols according to the pre-agreed way.

In addition to using the pre-agreed way, the information of the plurality of OFDM symbols for transmitting the first signal can also be sent by the network side device by means of a high layer signaling and/or a physical layer signaling. Specifically, the method may include, but is not limited to, the followings:

the first way: the high layer signaling includes indices or number of a plurality of OFDM symbols used for transmitting the first signal. That is, the terminal device receives the high layer signaling sent by the network side device, and obtains the indices or number of the plurality of OFDM symbols used for transmitting the first signal from the high layer signaling.

The second way: the physical layer signaling includes indices or number of the OFDM symbols used for transmitting the first signal. That is, the terminal device receives the physical layer signaling sent by the network side device, and obtains indices or number of the plurality of OFDM symbols used for transmitting the first signal from the physical layer signaling.

Where if the high layer signaling or the physical layer signaling includes the number information, the information of the OFDM symbols used for transmitting the first signal may be indicated by the way of combining multiple signalings. As an example, the high layer signaling includes an index of an initial OFDM symbol for transmitting the first signal, and the physical layer signaling includes the number of OFDM symbols used for transmitting the first signal. That is, the terminal device obtains the index of the initial OFDM symbol used for transmitting the first signal from the high layer signaling, obtains the number of OFDM symbols used for transmitting the first signal from the physical layer signaling, and further determines the indices of the plurality of OFDM symbols used for transmitting the first signal.

In 202, determining, by the terminal device, a frequency offset amount of each subcarrier of the plurality of OFDM symbols relative to a reference subcarrier.

Where the reference subcarrier may be, but not limited to, any one of the followings:

1) a subcarrier of the first OFDM symbol of the plurality of OFDM symbols, such as shown in FIG. 3, which may be a subcarrier of an OFDM symbol identified as n1.

2) a center carrier on system bandwidth.

3) a DC carrier. The DC carrier is an unused subcarrier at a center position of the LTE downlink carrier, and is a subcarrier set to avoid high interference due to possible leakage of the local crystal oscillator.

4) a first subcarrier of a physical resource block (PRB) where the plurality of OFDM symbols are located.

5) a subcarrier closest to a center frequency point of the system.

6) a center carrier on bandwidth allocated to the terminal device.

7) a center carrier on bandwidth for transmitting a sync signal.

In the embodiment of the present disclosure, each subcarrier for transmitting the plurality of OFDM symbols has a different frequency offset amount relative to the reference subcarrier, so that the transmission of the first signal is relatively evenly distributed in the frequency domain, instead of being concentrated on subcarriers at a specific frequency as in the prior art.

The above frequency offset is in units of a first subcarrier interval or a second subcarrier interval. As the indices of the OFDM symbols increase in the plurality of OFDM symbols, the frequency offset amount corresponding to the OFDM symbol also increases. For example, as shown in FIG. 3, assuming that the reference subcarrier is the first subcarrier of the OFDM symbol identified as m1, the offset amounts of the OFDM symbols identified as n1, n2, n3, and n4 are 0, a quarter of the first subcarrier interval, two quarters of the first subcarrier interval, and three quarters of the first subcarrier interval relative to the reference subcarrier, respectively.

In addition, when determining a frequency offset amount of each subcarrier of the plurality of OFDM symbols relative to the reference subcarrier, the frequency offset amount of each subcarrier of the plurality of OFDM symbols relative to the reference subcarrier can be determined according to the number of the plurality of OFDM symbols. For example, assuming that the number of the plurality of OFDM symbols used for transmitting the first signal is M, the frequency offset amount corresponding to the m^{th} OFDM symbol can be Q first subcarrier intervals, where

$$Q = \frac{( m - 1 )}{M} .$$

As an implementation, the above frequency offset amount can be p first subcarrier intervals, or K+p first subcarrier intervals, or K second subcarrier intervals, where 0≤p<1 and K is a natural number. For example, as shown in FIG. 3, the offset amounts of the OFDM symbols identified as n1, n2, n3, and n4 relative to the reference subcarrier are 0, a quarter of the first subcarrier interval, two quarters of the first subcarrier interval, and three quarters of the first subcarrier interval, respectively. They can also be seen as: 0, 1 second subcarrier interval, 2 second subcarrier intervals, and 3 second subcarrier intervals, respectively.

In the embodiment of the present disclosure, the frequency offset amount of each subcarrier of the plurality of OFDM symbols relative to the reference subcarrier can be configured in advance at the terminal device side, and the terminal device determines, according to the configuration, the frequency offset amount of each subcarrier of the above plurality of OFDM symbols relative to the reference subcarrier.

As a preferred implementation, the terminal device can receive the subcarrier offset indication information sent by the network side device, and obtain the frequency offset amount of each subcarrier of the plurality of OFDM symbols relative to the reference subcarrier from the subcarrier offset indication information.

Where when receiving the subcarrier offset indication information sent by the network side device, the terminal device can use, but not be limited to, one of the following ways:

the first way: receiving the high layer signaling sent by the network side device, where the high layer signaling includes the subcarrier offset indication information.

The second way: receiving the high layer signaling and downlink control information (DCI) signaling sent by the network side device, where the information included in the high layer signaling and the information included in the DCI signaling are combined to constitute the subcarrier offset indication information.

In this way, the high layer signaling may include a plurality of candidate subcarrier offset indication information, and the DCI signaling includes indicating which subcarrier offset indication information in the above plurality of candidate subcarrier offset indication information is used.

When the frequency offset amount of each subcarrier of the plurality of OFDM symbols relative to the reference subcarrier is obtained from the subcarrier offset indication information, one of the following ways may be used, but is not limited to:

The first way: obtaining, from the subcarrier offset indication information, a frequency offset amount of each subcarrier of one OFDM symbol of the plurality of OFDM symbols relative to the reference subcarrier; and then determining, according to a pre-agreed subcarrier relative frequency offset amount among the OFDM symbols, a frequency offset amount of each subcarrier of the other OFDM symbols in the plurality of OFDM symbols relative to the reference subcarrier. That is to say, the frequency offset amount corresponding to one of the OFDM symbols is sent by the network side device, and the subcarrier relative frequency offset amount among the OFDM symbols uses a pre-agreed value.

For example, as shown in FIG. 3, it is assumed that the offset amount of the subcarrier of the OFDM symbol identified as n1 relative to the reference subcarrier obtained according to the subcarrier offset indication information sent by the network side device is 0; and the relative offset amount among respective OFDM symbols uses an agreed value, and if the agreed value is a quarter of the first subcarrier interval, it can be determined that the offset amounts of the OFDM symbols identified as n2, n3, and n4 are a quarter of the first subcarrier interval, two quarters of the first subcarrier interval, and three quarters of the first subcarrier interval relative to the reference subcarrier, respectively. Of course, the frequency offset amount of each subcarrier of other OFDM symbols (for example, OFDM symbols identified as n2, n3, or n4) relative to the reference subcarrier can also be specified in high layer signaling. In this example, only the frequency offset amount corresponding to the OFDM symbol identified as n1 specified in high layer signaling is taken as an example.

The second way: obtaining, from the subcarrier offset indication information, a subcarrier relative frequency offset amount among the OFDM symbols; and determining, according to a pre-agreed frequency offset amount of each subcarrier of one OFDM symbol of the plurality of OFDM symbols relative to the reference subcarrier, a frequency offset amount of each subcarrier of the other OFDM symbols in the plurality of OFDM symbols relative to the reference subcarrier. That is to say, the frequency offset amount corresponding to one of the OFDM symbols uses a pre-agreed value, and the subcarrier relative frequency offset amount among the OFDM symbols is sent by the network side device.

For example, as shown in FIG. 3, the relative offset amount among respective OFDM symbols is obtained according to the subcarrier offset indication information sent by the network side device, and it is assumed that the relative offset amount is a quarter of the first subcarrier interval, the offset amount of the subcarrier of the OFDM symbol identified as n1 relative to the reference subcarrier uses the pre-agreed value which is assumed to be 0, then it can be determined that the offset amounts of the OFDM symbols identified as n2, n3, and n4 relative to the reference subcarrier are a quarter of the first subcarrier interval, two quarters of the first subcarrier interval, and three quarters of the first subcarrier interval, respectively.

The third way: obtaining, from the subcarrier offset indication information, a frequency offset amount of each subcarrier of one OFDM symbol of the plurality of OFDM symbols relative to the reference subcarrier, and a subcarrier relative frequency offset amount among the OFDM symbols, so as to determine the frequency offset amount of each subcarrier of the plurality of OFDM symbols relative to the reference subcarrier. That is to say, the frequency offset amount corresponding to one of the OFDM symbols and the subcarrier relative frequency offset amount among the OFDM symbols are sent by the network side device.

For example, as shown in FIG. 3, from the subcarrier offset indication information sent by the network side device, the relative offset amount among respective OFDM symbols is obtained, and it is assumed to be a quarter of a first subcarrier interval, and the offset amount of the subcarrier of the OFDM symbol identified as n1 relative to the reference subcarrier is also obtained, and it is assumed to be 0, then it can be determined that the offset amounts of the OFDM symbols identified as n2, n3, and n4 relative to the reference subcarrier are a quarter of the first subcarrier interval, two quarters of the first subcarrier interval, and three quarters of the first subcarrier interval, respectively.

In 203, sending or receiving, by the terminal device, the first signal on the subcarriers of the plurality of OFDM symbols according to the determined frequency offset amount.

In the frequency domain, the terminal device can determine the frequency positions of the subcarriers of each OFDM symbol in the plurality of OFDM symbols according to the determined frequency offset amount and the frequency position of the reference subcarrier; and the terminal device sends or receives the first signal on the frequency positions of these subcarriers.

In the time domain, the terminal device can determine a phase or a delay of the time domain signal transmitting the first signal on the plurality of OFDM symbols according to the determined frequency offset amount; and then send or receive, according to the phase or the delay of the time domain signal, the first signal on the plurality of OFDM symbols.

Where, for the first signal, for example, the reference information such as an SRS, a DMRS, the uplink control information, or the uplink data, the terminal device sends the first signal on the above plurality of OFDM symbols. For the first signal, for example, the reference signal such as a CSI-RS, the downlink control information, or the downlink data, the terminal device receives the first signal on the above plurality of OFDM symbols.

In this step, since the frequency offset of the subcarrier exists among the determined plurality of OFDM symbols, that is, the frequency points where subcarriers corresponding to the same subcarrier index on the plurality of OFDM symbols are located are different, thus, as shown in FIG. 3, when the first signal is transmitted on the subcarriers of the plurality of OFDM symbols, the first signal is no longer concentrated on a specific subcarrier, but is dispersed more evenly. This way enables the interference of the transmission of the first signal is more even for the data being transmitted by the neighboring cell terminal device. On one hand, the influence on the data demodulation of the neighboring cell terminal device is reduced; and on the other hand, if the neighboring cell performs interference measurement, the difference in measurement results on different subcarriers is reduced and the accuracy of the interference measurement result is improved.

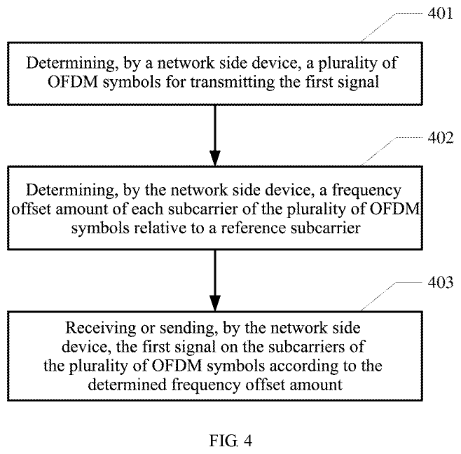

FIG. 4 is a flow chart of a method performed by a network side device provided by an embodiment of the present disclosure. As shown in FIG. 4, the method can include the following steps:

in 401, determining, by a network side device, a plurality of OFDM symbols for transmitting the first signal.

The related description of the plurality of OFDM symbols may be referred to the related description in step 201 of the embodiment shown in FIG. 2, and details are not described herein again.

In addition, the plurality of OFDM symbols used for transmitting the first signal can be determined in a pre-agreed way, that is, the terminal device and the network side device pre-agree indices of the plurality of OFDM symbols used for transmitting the first signal, and both of them determine the positions of plurality of OFDM symbols according to the pre-agreed way.

In addition to using the pre-agreed way, the information of transmitting the plurality of OFDM symbols for transmitting the first signal can also be sent by the network side device by means of a high layer signaling and/or a physical layer signaling, Specifically, it can include, but is not limited to, the following ways:

the first way: the high layer signaling includes indices or number of a plurality of OFDM symbols for transmitting the first signal.

The second way: the physical layer signaling includes indices or number of the OFDM symbols used for transmitting the first signal.

Where if the high layer signaling or the physical layer signaling includes the number information, the information of the OFDM symbols used for transmitting the first signal may be indicated by the way of combining multiple signalings. As an example, the high layer signaling includes an index of an initial OFDM symbol for transmitting the first signal, and the physical layer signaling includes the number of OFDM symbols used for transmitting the first signal.

In 402, determining, by the network side device, a frequency offset amount of each subcarrier of the plurality of OFDM symbols relative to a reference subcarrier.

The description of the reference subcarrier and the frequency offset amount may be referred to the related description in step 202 in the embodiment shown in FIG. 2, and details are not described herein again.

In the embodiment of the present disclosure, the frequency offset amount of each subcarrier of the plurality of OFDM symbols relative to the reference subcarrier may be configured in advance on the network side device, and the network side device determines, according to the configuration, the frequency offset amount of each subcarrier of the plurality of OFDM symbols relative to the frequency offset of the reference subcarrier.

As a preferred implementation, after determining a frequency offset amount of each subcarrier for transmitting the first signal on the plurality of OFDM symbols relative to the reference subcarrier, the network side device can send the subcarrier offset indication information to the terminal device. Where the subcarrier offset indication information includes the frequency offset amount of each subcarrier of the plurality of OFDM symbols relative to the reference subcarrier.

When sending the subcarrier offset indication information to the terminal device, the network side device can use, but not be limited to, one of the following methods:

the first way: sending the high layer signaling to the terminal device, where the high layer signaling includes the subcarrier offset indication information.

The second way: sending the high layer signaling and the DCI signaling to the terminal device, where the information included in the high layer signaling and the information included in DCI signaling are combined to constitute the subcarrier offset indication information.

In this way, the high layer signaling may include a plurality of candidate subcarrier offset indication information, and the DCI signaling includes indicating which subcarrier offset indication information in the above plurality of candidate subcarrier offset indication information is used.

The way in which the network side device sends the subcarrier offset indication information may be, but not limited to, one of the following ways:

the first way: the subcarrier offset indication information includes a frequency offset amount of each subcarrier of one OFDM symbol of the plurality of OFDM symbols relative to the reference subcarrier; and the subcarrier relative frequency offset amount among the OFDM symbols is pre-agreed by the network side device and the terminal device. That is to say, the frequency offset amount corresponding to one of the OFDM symbols is sent by the network side device to the terminal device, and the subcarrier relative frequency offset amount among the OFDM symbols uses a pre-agreed value.

The second way: the subcarrier offset indication information includes a subcarrier relative frequency offset amount among OFDM symbols; and a frequency offset amount of each subcarrier of one OFDM symbol of the plurality of OFDM symbols relative to the reference subcarrier is pre-agreed by the network side device and the terminal device. That is to say, the frequency offset amount corresponding to one of the OFDM symbols uses a pre-agreed value, and the subcarrier relative frequency offset amount among the OFDM symbols is sent by the network side device to the terminal device.

The third way: the subcarrier offset indication information includes a frequency offset amount of each subcarrier of one OFDM symbol of the plurality of OFDM symbols relative to the reference subcarrier, and the subcarrier relative frequency offset amount among the OFDM symbols. That is to say, the frequency offset amount corresponding to one of the OFDM symbols and the subcarrier relative frequency offset amount among the OFDM symbols are sent by the network side device to the terminal device.

In 403, receiving or sending, by the network side device, the first signal on the subcarriers of the plurality of OFDM symbols according to the determined frequency offset amount.

In the frequency domain, the network side device can determine the frequency positions of the subcarriers of each OFDM symbol of the plurality of OFDM symbols according to the determined frequency offset amount and the frequency position of the reference subcarrier; and the network side device receives or sends the first signal on the frequency positions of these subcarriers.

In the time domain, the network side device can determine a phase or a delay of the time domain signal transmitting the first signal on the plurality of OFDM symbols according to the determined frequency offset amount; and then send or receive the first signal on the plurality of OFDM symbols according to the phase or the delay of the time domain signal.

For the first signal, for example, the reference information such as an SRS, a DMRS, the uplink control information, or the uplink data, the network side device receives the first signal on the subcarriers of the above plurality of OFDM symbols. For the first signal, for example, the reference signal such as a CSI-RS, the downlink control information, or the downlink data, the network side device sends the first signal on the subcarriers of the above plurality of OFDM symbols.

The above is the description of the method provided by the present disclosure, and the apparatus provided by the present disclosure will be described in detail below with reference to embodiments.

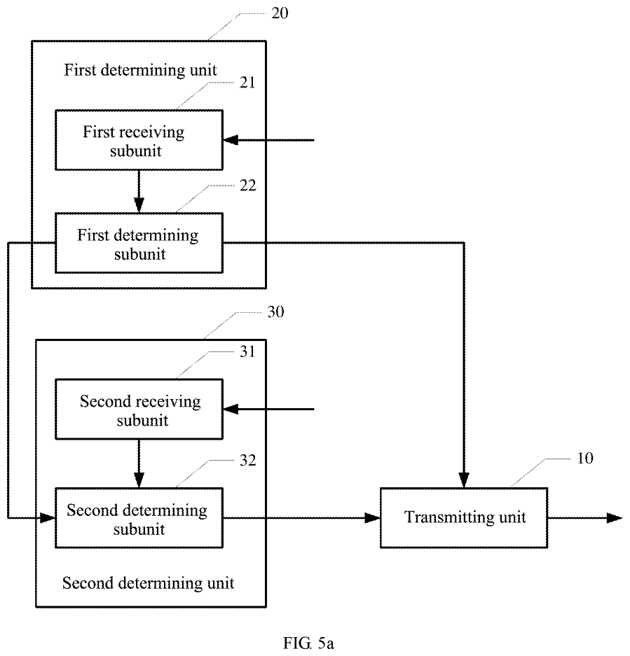

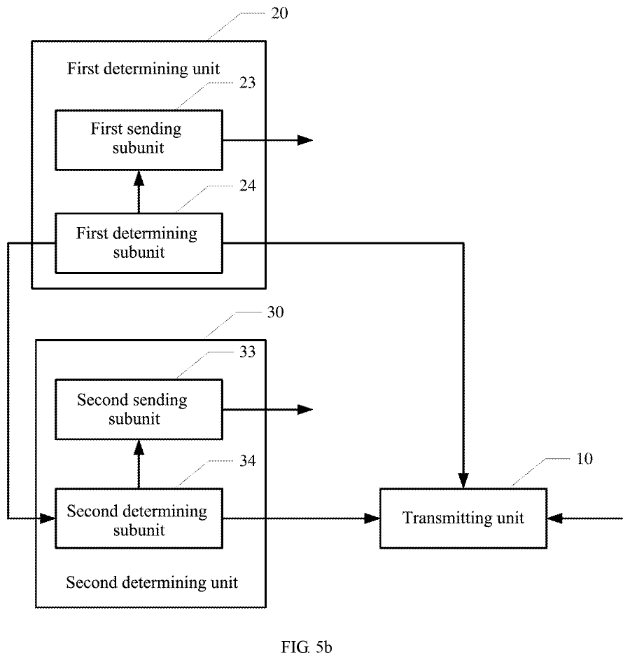

FIG. 5a is a schematic structural diagram of an apparatus provided by an embodiment of the present disclosure. As shown in FIG. 5a, the apparatus can include: a transmitting unit 10, and can further include a first determining unit 20 and a second determining unit 30. Where the main functions of each component are as follows:

the transmitting unit 10 is responsible for transmitting a first signal on subcarriers of a plurality of orthogonal frequency division multiplexed (OFDM) symbols, where a frequency offset of the subcarriers exists among the plurality of OFDM symbols.

Where the first signal may include, but is not limited to, reference information such as a CSI-RS, an SRS, a DMRS, or control information, or data.

Where the apparatus can be disposed in a terminal device, for the first signal, for example, the reference information such as the SRS, the DMRS, the uplink control information, or the uplink data, then the transmitting unit 10 is specifically configured to send the first signal on the subcarriers of the plurality of the OFDM symbols. For the first signal, for example, the reference signal such as a CSI-RS, the downlink control information, or the downlink data, the transmitting unit 10 is specifically configured to receive the first signal on subcarriers of the plurality of OFDM symbols.

The apparatus can be further disposed in a network side device, for the first signal, for example, the reference information such as an SRS, a DMRS, the uplink control information, or the uplink data, the transmitting unit 10 is specifically configured to receive the first signal on the subcarriers of the plurality of the OFDM symbols. For the first signal, for example, the reference signal such as a CSI-RS, the downlink control information, or the downlink data, the transmitting unit 10 is specifically configured to send the first signal on subcarriers of the plurality of OFDM symbols.

Where the plurality of OFDM symbols used for transmitting the first signal can be continuous in the time domain. If the first signal includes: a CSI-RS, an SRS, a DMRS, or control information, the total duration of the plurality of OFDM symbols can be: a duration of one OFDM symbol for transmitting data in a slot or a subframe where the plurality of OFDM symbols are located, or a duration of one OFDM symbol obtained according to a subcarrier interval determining a length of the subframe where the plurality of OFDM symbols are located.

If the first signal includes the first data, the total duration of the plurality of OFDM symbols can be: a duration of one OFDM symbol obtained according to a subcarrier interval that determines a subframe length where the plurality of OFDM symbols are located.

The first subcarrier interval used for transmitting the first signal on the subcarriers of the plurality of OFDM symbols is different from the second subcarrier interval, where the second subcarrier interval is a subcarrier interval used for transmitting data (if the first signal is a non-data type signal, the “transmitting data” here is the data transmitted by the terminal device; if the first signal is a data type signal, the “transmitting data” here is the data transmitted by the other terminal device, such as a neighboring cell terminal device) in the slot or the subframe where the plurality of OFDM symbols are located, or a subcarrier interval for determining the length of the subframe where the plurality of OFDM symbols are located. The length of the OFDM symbol used for transmitting the reference signal, the control signal in the subframe can be determined according to the length of the subframe. That is, there is a correspondence relationship between the length of the OFDM symbol and the length of the subframe, and once the length of the subframe is determined, correspondingly, the total length of the OFDM symbol used for transmitting the first signal in the embodiment of the present disclosure can also be determined.

Usually the first subcarrier interval is greater than the second subcarrier interval. In an embodiment, the first subcarrier interval is 2ⁿ times the second subcarrier interval, where n is a positive integer.

The first determining unit 20 is responsible for determining a plurality of OFDM symbols for transmitting the first signal.

Where if the apparatus is disposed in the terminal device, the first determining unit 20 can specifically include: a first receiving subunit 21 and a first determining subunit 22.

Where the first receiving subunit 21 is responsible for receiving high layer signaling and/or physical layer signaling sent by the network side device.

The first determining subunit 22 is responsible for determining a plurality of OFDM symbols for transmitting the first signal according to the high layer signaling and/or the physical layer signaling.

Where the first determining unit 20 may specifically include: a first sending subunit 23 and a first determining subunit 24, if the apparatus is disposed in the network side device, as shown in FIG. 5b.

The first determining subunit 24 is responsible for determining a plurality of OFDM symbols for transmitting the first signal. The first sending subunit 23 is responsible for transmitting the high layer signaling and/or physical layer signaling to the terminal device. Where the high layer signaling can include indices or number of the plurality of OFDM symbols used for transmitting the first signal. That is, the terminal device obtains the indices or number of the plurality of OFDM symbols from the high layer signaling sent by the network side device.

Alternatively, the physical layer signaling can include the indices or number of the plurality of OFDM symbols used for transmitting the first signal. That is, the terminal device obtains the indices or number of the plurality of OFDM symbols from the physical layer signaling sent by the network side device.

Where if the high layer signaling or the physical layer signaling includes the number information, the information of the OFDM symbols used for transmitting the first signal can be indicated by the way of combining a plurality of signalings. As an example: the high layer signaling includes an index of an initial OFDM symbol used for transmitting the first signal, and the physical layer signaling includes the number of OFDM symbols used for transmitting the first signal. That is, the terminal device obtains the index of the initial OFDM symbol from the high layer signaling sent by the network side device, obtains the number of the plurality of OFDM symbols from the physical layer signaling, and further determines the indices of the plurality of OFDM symbols used for transmitting the first signal.

The second determining unit 30 is responsible for determining the frequency offset amount of each subcarrier of the plurality of OFDM symbols relative to the reference subcarrier.

Where the second determining unit 30 can specifically include: a second receiving subunit 31 and a second determining subunit 32, if the apparatus is disposed in the terminal device, as shown in FIG. 5a.

Where the second receiving subunit 31 is responsible for receiving the subcarrier Offset indication information sent by the network side device.

The second determining subunit 32 is responsible for determining the frequency offset amount of each subcarrier of the plurality of OFDM symbols relative to the reference subcarrier according to the subcarrier offset indication information.

Specifically, the second receiving subunit 31 can receive the high layer signaling sent by the network side device, where the high layer signaling includes the subcarrier offset indication information; or receive the high layer signaling and the downlink control information (DCI) signaling sent by the network side device, where the combination of the information included in the high layer signaling and the DCI signaling constitutes the subcarrier offset indication information.

If the apparatus is disposed on the network side device, the second determining unit 30 can include a second sending subunit 33 and a second determining subunit 34, as shown in FIG. 5b.

The second determining subunit 34 is responsible for determining the frequency offset amount of each subcarrier on the plurality of OFDM symbols used for transmitting the first signal relative to the reference subcarrier. The second sending subunit 33 is responsible for sending the subcarrier offset indication information to the terminal device, where the subcarrier offset indication information includes a frequency offset of each subcarrier of the plurality of OFDM symbols relative to the reference subcarrier. Specifically, the second sending subunit 33 may send high layer signaling to the terminal device, where the high layer signaling includes the subcarrier offset indication information; or send the high layer signaling and the downlink control information (DCI) signaling to the terminal device, where the combination of information included in the high layer signaling and the DCI signaling constitutes the subcarrier offset indication information.

The situation that the above combination of information included in the high layer signaling and the DCI signaling constitutes the subcarrier offset indication information can be: the high layer signaling includes multiple candidate subcarrier offset indication information, and the DCI signaling includes indicating which subcarrier offset indication information in the plurality of the candidate subcarrier offset indication information is used.

The above second determining subunit 32 can be specifically, but not limited to, perform the followings:

the first way: obtaining, according to the subcarrier offset indication information, a frequency offset amount of each subcarrier of one OFDM symbol of the plurality of OFDM symbols relative to the reference subcarrier; and determining, according to the pre-agreed subcarrier relative frequency offset amount among the OFDM symbols, a frequency offset amount of each subcarrier of the other OFDM symbols in the plurality of OFDM symbols relative to the reference subcarrier.

The second way: obtaining, according to the subcarrier offset indication information, a subcarrier relative frequency offset amount among the OFDM symbols; and determining, according to the pre-agreed frequency offset amount of each subcarrier of one OFDM symbol of the plurality of OFDM symbols relative to the reference subcarrier, a frequency offset amount of each subcarrier of the other OFDM symbols in the plurality of OFDM symbols relative to the reference subcarrier.

The third way: obtaining, according to the subcarrier offset indication information, a frequency offset amount of each subcarrier of one OFDM symbol of the plurality of OFDM symbols relative to the reference subcarrier, and a subcarrier relative frequency offset amount among the OFDM symbols, so as to determine the frequency offset amount of each subcarrier of the plurality of OFDM symbols relative to the reference subcarrier.

The above reference subcarrier may include, but is not limited to, one of the followings:

1) a subcarrier of a first OFDM symbol of the plurality of OFDM symbols;

2) a first subcarrier of a physical resource block (PRB) where the plurality of OFDM symbols are located;

3) a center carrier on system bandwidth;

4) a DC carrier;

5) a subcarrier closest to a center frequency point;

6) a center carrier on bandwidth allocated to the terminal device; or

7) a center carrier on bandwidth for transmitting a sync signal.

Where the frequency offset is in units of the first subcarrier interval or the second subcarrier interval;

the first subcarrier interval is a subcarrier interval used for transmitting the first signal on the subcarriers of the plurality of OFDM symbols; and

the second subcarrier interval is a subcarrier interval used for transmitting data in a slot or a subframe where the plurality of OFDM symbols are located, or a subcarrier interval for determining a length of the subframe where the plurality of OFDM symbols are located.

As an implementation, in the above plurality of OFDM symbols, as the index of the OFDM symbol increases, the frequency offset amount corresponding to the OFDM symbol also increases.

In addition, the above second determining unit 30 may determine, according to the number of the plurality of OFDM symbols, a frequency offset amount of each subcarrier of the plurality of OFDM symbols relative to the reference subcarrier. For example, the frequency offset amount corresponding to the m^{th} OFDM symbol of the plurality of OFDM symbols is Q first subcarrier intervals; where

$$Q = \frac{( m - 1 )}{M} ,$$

and M is the total OFDM symbol number of the plurality of OFDM symbols.

In the embodiment of the present disclosure, the above frequency offset amount corresponding to the plurality of OFDM symbols may be: p first subcarrier intervals, or K+p first subcarrier intervals, or K second subcarrier intervals; where 0≤p<1 and K is a natural number.

In the frequency domain, the transmitting unit 10 determines, according to the determined frequency offset, the frequency positions of the subcarriers on each of the above plurality of OFDM symbols; and transmits the first signal on the determined frequency positions of the subcarriers on the plurality of OFDM symbols.

In the time domain, the transmitting unit 10 determines a phase or a delay of the time domain signal transmitting the first signal on the plurality of OFDM symbols according to the determined frequency offset; and transmits the first signal on the plurality of OFDM symbols according to the phase or the delay of the time domain signal.

The above method and apparatus provided by the embodiments of the present disclosure can be implemented by one or more integrated circuits, such as a codec chip, or can be accomplished by a program to instruct related hardware, where the program can be stored in a computer readable storage medium. Each unit in the above embodiment can be implemented in the form of hardware or in the form of a software function module. The present disclosure is not limited to any specific form of combination of hardware and software.

For example, it can be implemented by a device, where the device includes:

one or more processors;

a memory; and

one or more programs, where the one or more programs are stored in the memory, and are executed by the one or more processors to achieve the following operations:

transmitting a first signal on subcarriers of the plurality of OFDM symbols, where a frequency offset of the subcarriers exists among the plurality of OFDM symbols.

In addition, with the development of time and technology, the meaning of the medium is more and more extensive, and the propagation route of the program is no longer limited by the tangible medium, and can also be downloaded directly from the network. Any combination of one or more computer readable media can be used. The computer readable medium can be a computer readable signal medium or a computer readable storage medium. The computer readable storage medium can be, for example, but not limited to, electronic, magnetic, optical, electromagnetic, infrared, or a semiconductor system, an apparatus, or a device, or any combination of the above. More specific examples (non-exhaustive lists) of computer readable storage media include: an electrical connection having one or more wires, a portable computer disk, a hard disk, a random access memory (RAM), a read only memory (ROM), an erasable programmable read only memory (EPROM or a flash memory), optical fiber, a portable compact disk read only memory (CD-ROM), an optical storage device, a magnetic storage device, or any suitable combination of the above. In this document, a computer readable storage medium can be any tangible medium that can include or store a program, which can be used by or can be used in connection with an instruction execution system, apparatus or a device.

A computer readable signal medium may include data signals that is propagated in the baseband or as part of a carrier, which carries a computer readable program code. Such propagated data signals can take a variety of forms including, but not limited to, electromagnetic signals, optical signals, or any suitable combination of the above. The computer readable signal medium can also be any computer readable medium other than a computer readable storage medium, which can send, propagate, or transmit a program that used by or can be used in connection with an instruction execution system, an apparatus, or a device.

In the several embodiments provided by the present disclosure, it should be understood that the disclosed system, apparatus, and method can be implemented in other ways. For example, the above apparatus embodiments are merely illustrative. For example, the division of the unit is only a logical function division, and can have another division way when being implemented in actual.

The units described as separate components can or cannot be physically separated, and the components displayed as units can or cannot be physical units, that is, may be located in one place, or may be distributed to multiple network units. Some or all of the units may be selected according to actual requirements to achieve the purpose of the solution of the embodiment.

In addition, each functional unit in each embodiment of the present disclosure can be integrated into one processing unit, or each unit may exist physically separately, or two or more units may be integrated into one unit. The above integrated unit can be implemented in the form of hardware or in the form of hardware plus software functional units.

The above are only the preferred embodiments of the present disclosure, and are not intended to limit the present disclosure. Any modifications, substitutions, improvements, etc., which are made within the spirit and principles of the present disclosure, should be included in the scope of protection of the present disclosure.

What is claimed is:

1. A signal transmission method, comprising:
transmitting a first signal on subcarriers of a plurality of orthogonal frequency division multiplexing (OFDM) symbols, wherein a frequency offset of the subcarriers exists among the plurality of OFDM symbols.

2. The method according to claim 1, wherein the transmitting a first signal on subcarriers of a plurality of orthogonal frequency division multiplexing (OFDM) symbols comprises:
sending or receiving, by a terminal device, the first signal on the subcarriers of the plurality of OFDM symbols; or
receiving or sending, by a network side device, the first signal on the subcarriers of the plurality of OFDM symbols.

3. The method according to claim 1, wherein the first signal comprises at least one of a channel state information reference signal (CSI-RS), a channel sounding reference signal (SRS), a demodulation reference signal (DMRS), control information, and first data.

4. The method according to claim 1, wherein the plurality of OFDM symbols are continuous in time domain.

5. The method according to claim 1, wherein before the transmitting a first signal on subcarriers of a plurality of orthogonal frequency division multiplexing (OFDM) symbols, the method further comprises:
determining a frequency offset amount of each subcarrier of the plurality of OFDM symbols relative to a reference subcarrier.

6. The method according to claim 5, wherein the determining a frequency offset amount of each subcarrier of the plurality of OFDM symbols relative to a reference subcarrier comprises:
receiving subcarrier offset indication information sent by a network side device; and
determining, according to the subcarrier offset indication information, the frequency offset amount of each subcarrier of the plurality of OFDM symbols relative to the reference subcarrier.

7. The method according to claim 5, wherein the reference subcarrier comprises one of a subcarrier of a first OFDM symbol of the plurality of OFDM symbols;
a first subcarrier of a physical resource block (PRB) where the plurality of OFDM symbols are located;
a center carrier on system bandwidth;
a DC carrier;
a subcarrier closest to a center frequency point;
a center carrier on bandwidth allocated to the terminal device; and
a center carrier on bandwidth for transmitting a sync signal.

8. The method according to claim 1, wherein the frequency offset is in units of a first subcarrier interval or a second subcarrier interval;
wherein the first subcarrier interval is a subcarrier interval used for transmitting the first signal on the subcarriers of the plurality of OFDM symbols; and
the second subcarrier interval is a subcarrier interval used for transmitting second data in a slot or a subframe where the plurality of OFDM symbols are located, or a subcarrier interval for determining a length of the subframe where the plurality of OFDM symbols are located.

9. The method according to claim 5, wherein the determining a frequency offset amount of each subcarrier of the plurality of OFDM symbols relative to a reference subcarrier comprises:
determining, according to the number of the plurality of OFDM symbols, the frequency offset amount of each subcarrier of the plurality of OFDM symbols relative to the reference subcarrier.

10. The method according to claim 5, wherein the frequency offset amount is one of p first subcarrier intervals, K+p first subcarrier intervals, and K second subcarrier intervals;
wherein 0≤p<1 and K is a natural number,
the first subcarrier interval is a subcarrier interval used for transmitting the first signal on the subcarriers of the plurality of OFDM symbols; and
the second subcarrier interval is a subcarrier interval used for transmitting second data in a slot or a subframe where the plurality of OFDM symbols are located, or a subcarrier interval for determining a length of the subframe where the plurality of OFDM symbols are located.

11. A signal transmission apparatus, comprising: one or more processors, a memory, and one or more programs, wherein the one or more programs are stored in the memory, which, when executed by the one or more processors, cause the one or more processors to:
transmit a first signal on subcarriers of a plurality of orthogonal frequency division multiplexing (OFDM) symbols, wherein a frequency offset of the subcarriers exists among the plurality of OFDM symbols.

12. The apparatus according to claim 11, wherein the apparatus is disposed in a terminal device, wherein the one or more programs further cause the one or more processors to: send or receive the first signal on the subcarriers of the plurality of OFDM symbols; or
the apparatus is disposed in a network side device, and the one or more programs further cause the one or more processors to: receive or send the first signal on the subcarriers of the plurality of OFDM symbols.

13. The apparatus according to claim 11, wherein the first signal comprises at least one of a channel state information reference signal (CSI-RS), a channel sounding reference signal (SRS), a demodulation reference signal (DMRS), control information, and first data.

14. The apparatus according to claim 11, wherein the plurality of OFDM symbols are continuous in time domain.

15. The apparatus according to claim 11, wherein the one or more programs further cause the one or more processors to:
determine a frequency offset amount of each subcarrier of the plurality of OFDM symbols relative to a reference subcarrier.

16. The apparatus according to claim 15, wherein the one or more programs further cause the one or more processors to:
receive subcarrier offset indication information sent by a network side device; and
determine, according to the subcarrier offset indication information, the frequency offset amount of each subcarrier of the plurality of OFDM symbols relative to the reference subcarrier.

17. The apparatus according to claim 15, wherein the reference subcarrier comprises one of a subcarrier of a first OFDM symbol of the plurality of OFDM symbols;
a first subcarrier of a physical resource block (PRB) where the plurality of OFDM symbols are located;
a center carrier on system bandwidth;
a DC carrier;
a subcarrier closest to a center frequency point;
a center carrier on bandwidth allocated to the terminal device; and
a center carrier on bandwidth for transmitting a sync signal.

18. The apparatus according to claim 11, wherein the frequency offset is in units of a first subcarrier interval or a second subcarrier interval;
wherein the first subcarrier interval is a subcarrier interval used for transmitting the first signal on the subcarriers of the plurality of OFDM symbols; and
the second subcarrier interval is a subcarrier interval used for transmitting second data in a slot or a subframe where the plurality of OFDM symbols are located, or a subcarrier interval for determining a length of the subframe where the plurality of OFDM symbols are located.

19. The apparatus according to claim 15, wherein the one or more programs further cause the one or more processors to:
determine, according to the number of the plurality of OFDM symbols, the frequency offset amount of each subcarrier of the plurality of OFDM symbols relative to the reference subcarrier.

20. The apparatus according to claim 15, wherein the frequency offset amount is one of p first subcarrier intervals, K+p first subcarrier intervals, and K second subcarrier intervals;
wherein 0≤p<1 and K is a natural number,
the first subcarrier interval is a subcarrier interval used for transmitting the first signal on the subcarriers of the plurality of OFDM symbols; and
the second subcarrier interval is a subcarrier interval used for transmitting second data in a slot or a subframe where the plurality of OFDM symbols are located, or a subcarrier interval for determining a length of the subframe where the plurality of OFDM symbols are located.
